(19) United States
(12) Patent Application Publication
(10) Pub. No.: US 2017/0089207 A1
(43) Pub. Date: Mar. 30, 2017

(54) TURBINE AIRFOIL COOLING SYSTEM WITH LEADING EDGE IMPINGEMENT COOLING SYSTEM AND NEARWALL IMPINGEMENT SYSTEM

(71) Applicant: Siemens Energy, Inc., Orlando, FL (US)

(72) Inventors: Jan H. Marsh, Orlando, FL (US); Ralph W. Matthews, Oviedo, FL (US)

(21) Appl. No.: 15/307,062

(22) PCT Filed: Jun. 17, 2014
(86) PCT No.: PCT/US14/42604

§ 371 Date: Oct. 27, 2016

(51) Int. Cl. F01D 5/18

(52) U.S. Cl. CPC F01D 5/188; F05D 2240/303; F05D 2260/201

(57) ABSTRACT

A turbine airfoil (10) usable in a turbine engine and having an internal cooling system (14) with a leading edge impingement channel (16) for enhanced cooling of the leading edge (18) of the turbine airfoil (10) without a leading edge film cooling showerhead array is disclosed. The internal cooling system (14) may include an leading edge cooling supply channel (20) formed from a leading edge wall (22) having a leading edge tip (24) that is advanced closer to an inner surface (26) of the leading edge (18) of the generally elongated, hollow airfoil (28) than other aspects of the leading edge cooling supply channel (20). The leading edge cooling supply channel (20) may include leading edge impingement orifices (30) for directing cooling fluids to impinge on the inner surface (26) of the leading edge (18) of the airfoil (28). The internal cooling system (14) may also include one or more nearwall ribs (92) with impingement orifices (90) in the leading edge cooling supply channel (20) for providing additional cooling of the nearwalls.

### STATEMENT REGARDING FEDERALLY SPONSORED RESEARCH OR DEVELOPMENT

Development of this invention was supported in part by the United States Department of Energy, Advanced Turbine Development Program, Contract No. DE-FC26-05NT42644. Accordingly, the United States Government may have certain rights in this invention.

### FIELD OF THE INVENTION

This invention is directed generally to turbine airfoils, and more particularly to leading edge cooling systems in hollow turbine airfoils of gas turbine engines.

### BACKGROUND

Typically, gas turbine engines include a compressor for compressing air, a combustor for mixing the compressed air with fuel and igniting the mixture, and a turbine blade assembly for producing power. Combustors often operate at high temperatures that may exceed 2,500 degrees Fahrenheit. Typical turbine combustor configurations expose turbine blade assemblies to these high temperatures. As a result, turbine blades must be made of materials capable of withstanding such high temperatures. In addition, turbine blades often contain cooling systems for prolonging the life of the blades and reducing the likelihood of failure as a result of excessive temperatures.

Typically, turbine blades are formed from a root portion having a platform at one end and an elongated portion forming a blade that extends outwardly from the platform coupled to the root portion. The blade is ordinarily composed of a tip opposite the root section, a leading edge, and a trailing edge. The inner aspects of most turbine blades typically contain an intricate maze of cooling channels forming a cooling system. The cooling channels in a blade receive air from the compressor of the turbine engine and pass the air through the blade. The cooling channels often include multiple flow paths that are designed to maintain all aspects of the turbine blade at a relatively uniform temperature. However, centrifugal forces and air flow at boundary layers often prevent some areas of the turbine blade from being adequately cooled, which results in the formation of localized hot spots. Localized hot spots, depending on their location, can reduce the useful life of a turbine blade and can damage a turbine blade to an extent necessitating replacement of the blade. Vanes likewise develop localized hot spots that can reduce the useful life of a turbine vane. Typically, the leading edge of turbine airfoils includes a plurality of film cooling holes forming a showerhead. While the showerhead of film cooling holes cools the leading edge, conventional showerhead configurations are often inefficient.

### SUMMARY OF THE INVENTION

A turbine airfoil usable in a turbine engine and having an internal cooling system with a leading edge impingement channel for enhanced cooling of the leading edge of the turbine airfoil without a leading edge film cooling showerhead is disclosed. The internal cooling system may include a leading edge cooling supply channel formed from a leading edge wall having a leading edge tip that is advanced closer to an inner surface of the leading edge of the generally elongated, hollow airfoil than other aspects of the leading edge cooling supply channel. The leading edge cooling supply channel may include one or more leading edge impingement orifices for directing cooling fluids to impinge on the inner surface of the leading edge of the airfoil in the leading edge impingement channel. The internal cooling system may also include one or more nearwall ribs with impingement orifices in the leading edge cooling supply channel for providing additional cooling of the outer walls.

In at least one embodiment, the turbine airfoil may be a turbine blade or vane. The turbine airfoil may be formed from a generally elongated, hollow airfoil having a leading edge, a trailing edge, a pressure side, a suction side, a tip at a first end, a root coupled to the airfoil at a second end generally opposite to the first end for supporting the airfoil and for coupling the airfoil to a disc, and an internal cooling system formed from at least one cavity in the elongated, hollow airfoil. The internal cooling system may include a leading edge cooling supply channel and a leading edge impingement channel positioned within the generally elongated, hollow airfoil along the leading edge of the generally elongated, hollow airfoil. The leading edge cooling supply channel may be formed from a leading edge wall having a leading edge tip that is advanced closer to an inner surface of the leading edge of the generally elongated, hollow airfoil than other aspects of the leading edge cooling supply channel. In such a position, the leading edge cooling supply channel may send impingement fluids against the inner surface of the leading edge to cool the leading edge. The internal cooling system may also include one or more leading edge impingement orifices in the leading edge tip of the leading edge cooling supply channel for exhausting cooling fluids to impinge on the inner surface of the leading edge of the generally elongated, hollow airfoil in a leading edge impingement channel. The leading edge impingement orifice in the leading edge tip of the leading edge cooling supply channel may be formed from a plurality of leading edge impingement orifices aligned into one or more spanwise extending rows of leading edge impingement orifices.

The internal cooling system may also include one or more nearwall impingement orifices positioned within a nearwall rib in the leading edge cooling supply channel and one or more nearwall radial flow channels positioned aft of and downstream from the at least one nearwall impingement orifice. The internal cooling system may also include a first chordwise extending impingement rib separated spanwise from a second chordwise extending impingement rib, wherein the first chordwise extending impingement rib and the second chordwise extending impingement rib extend between the nearwall rib containing the at least one nearwall impingement orifice and leading edge of the airfoil.

The nearwall rib may extend spanwise within the leading edge cooling supply channel from an ID end of the leading edge cooling supply channel to an OD end of the leading edge cooling supply channel. In at least one embodiment, the nearwall rib may extend between the pressure side and a first leading edge section of the leading edge wall forming the leading edge cooling supply channel and may form a pressure side nearwall rib. The nearwall impingement orifice positioned within the nearwall rib in the leading edge cooling supply channel may be formed from a plurality of nearwall impingement orifices positioned within the pressure side nearwall rib. Similarly, the first and second chordwise extending impingement ribs may be formed from a plurality of first and second chordwise extending impingement ribs extending chordwise from the pressure side nearwall rib. The first and second chordwise extending impingement ribs may be offset spanwise from inlets of the plurality of the nearwall impingement orifices. The nearwall rib may extend between the suction side and a second leading edge section of the leading edge wall forming the leading edge cooling supply channel and may form a suction side nearwall rib. The nearwall impingement orifice positioned within a nearwall rib in the leading edge cooling supply channel may include a plurality of nearwall impingement orifices positioned within the suction side nearwall rib. The first and second chordwise extending impingement ribs may include a plurality of first and second chordwise extending impingement ribs extending chordwise from the suction side nearwall rib. The first and second chordwise extending impingement ribs may be offset spanwise from inlets of the plurality of the nearwall impingement orifices.

The leading edge cooling supply channel may be formed from a first leading edge wall that extends spanwise and a second leading edge wall that extends spanwise and is coupled to the first leading edge wall forming the leading edge tip, whereby the first leading edge wall is nonorthogonal to the second leading edge wall. The first and second leading edge walls of the leading edge cooling supply channel may define a portion of the leading edge impingement channel formed from a pressure side section and a suction side section that is nonorthogonal to the pressure side section. In at least one embodiment, the pressure side section and the suction side section of the leading edge impingement channel may form a c-shaped cross-sectional leading edge impingement channel. The first leading edge wall may also be aligned with an outer wall forming the pressure side of the generally elongated hollow airfoil, and the second leading edge wall may be aligned with an outer wall forming the suction side of the generally elongated hollow airfoil. The leading edge cooling supply channel may be formed from a first aft edge wall that extends spanwise and a second aft edge wall that extends spanwise and is coupled to the first aft edge wall forming a trailing edge tip, wherein the first aft edge wall is nonorthogonal to the second aft edge wall.

The leading edge cooling supply channel may be offset from an outer wall forming the pressure side and an outer wall forming the suction side of the generally elongated hollow airfoil. In particular, the leading edge cooling supply channel may be supported by a pressure side rib extending between the outer wall forming the pressure side of the generally elongated hollow airfoil and the first leading edge wall of the leading edge cooling supply channel and may be supported by a suction side rib extending between the outer wall forming the suction side of the generally elongated hollow airfoil and the second leading edge wall of the leading edge cooling supply channel.

An advantage of the leading edge cooling supply channel with leading edge impingement orifices provides enhanced near wall impingement with higher heat transfer augmentation without film cooling at the leading edge of the airfoil, unlike most conventional systems.

Another advantage of the leading edge cooling supply channel is that the leading edge cooling supply channel provides an intermediate channel to feed near wall impingement at the leading edge.

Yet another advantage of the leading edge cooling supply channel is that the ability to reduce the distance between the leading edge cooling supply channel and the leading edge is that there is more flexibility in designing interior aspects of the airfoil, such as enabling ribs to be widened within the airfoil and for internal passages to be added.

Still another advantage of the internal cooling system is that a better cooling distribution may be achieved through the combination of impingement array and the nearwall impingement orifice and nearwall radial flow channel that pull flow towards the edges of the impingement passage along the outer wall.

Another advantage of the internal cooling system is that the internal cooling system experiences higher back side convective cooling.

Yet another advantage of the internal cooling system is that there is no need for film cooling and thus, all showerhead holes have been removed.

Another advantage of the internal cooling system is that the turbine airfoil has increased resistance to thermal barrier coating spallation because of the lack of leading edge showerhead.

Still another advantage of the internal cooling system is that internal cooling system experiences increased component cooling efficiency.

Another advantage of the internal cooling system is that the internal cooling system experiences a reduction in cooling fluid flow due to less film cooling requirements as well as improved back side cooling due to better distribution and higher magnitude of cold side heat transfer coefficients.

Yet another advantage of the internal cooling system is that the nearwall impingement orifices may be angled to direct fluids to impinge upon the inner surfaces of the outer walls forming the pressure side or suction side, or both, thereby increasing the cooling capacity of the internal cooling system.

Another advantage of the invention is the internal cooling system may include two subsystems of impingement, the leading edge impingement orifices and the nearwall impingement orifices.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a perspective view of a turbine airfoil having features according to the invention.

FIG. 2 is a cross-sectional view of the turbine airfoil shown in FIG. 1 taken along section line 2-2 in FIG. 1.

FIG. 3 is a schematic diagram of the internal cooling system within the turbine airfoil of FIG. 2.

FIG. 4 is a detail view of the leading edge impingement channel and the leading edge cooling supply channel shown at detail line 4-4 in FIG. 2.

FIG. 5 is a cross-sectional view of the leading edge impingement channel shown in FIG. 1 taken along section line 5-5 in FIG. 4.

### DETAILED DESCRIPTION OF THE INVENTION

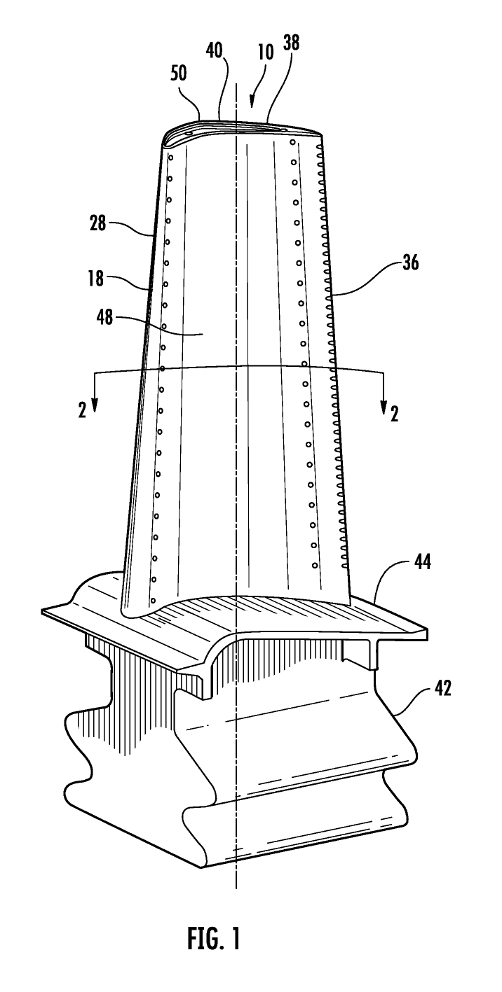

As shown in FIGS. 1-5, a turbine airfoil 10 usable in a turbine engine and having an internal cooling system 14 with a leading edge impingement channel 16 for enhanced cooling of the leading edge 18 of the turbine airfoil 10 without a leading edge film cooling showerhead is disclosed. The internal cooling system 14 may include an leading edge cooling supply channel 20 formed from a leading edge wall 22 having a leading edge tip 24 that is advanced closer to an inner surface 26 of the leading edge 18 of the generally elongated, hollow airfoil 28 than other aspects of the leading edge cooling supply channel 20. The leading edge cooling supply channel 20 may include one or more leading edge impingement orifices 30 for directing cooling fluids to impinge on the inner surface 26 of the leading edge 18 of the airfoil 28 in the leading edge impingement channel 20. The internal cooling system 14 may also include one or more nearwall ribs 92 with impingement orifices 90 in the leading edge cooling supply channel 20 for providing additional cooling of the outer walls 56, 58.

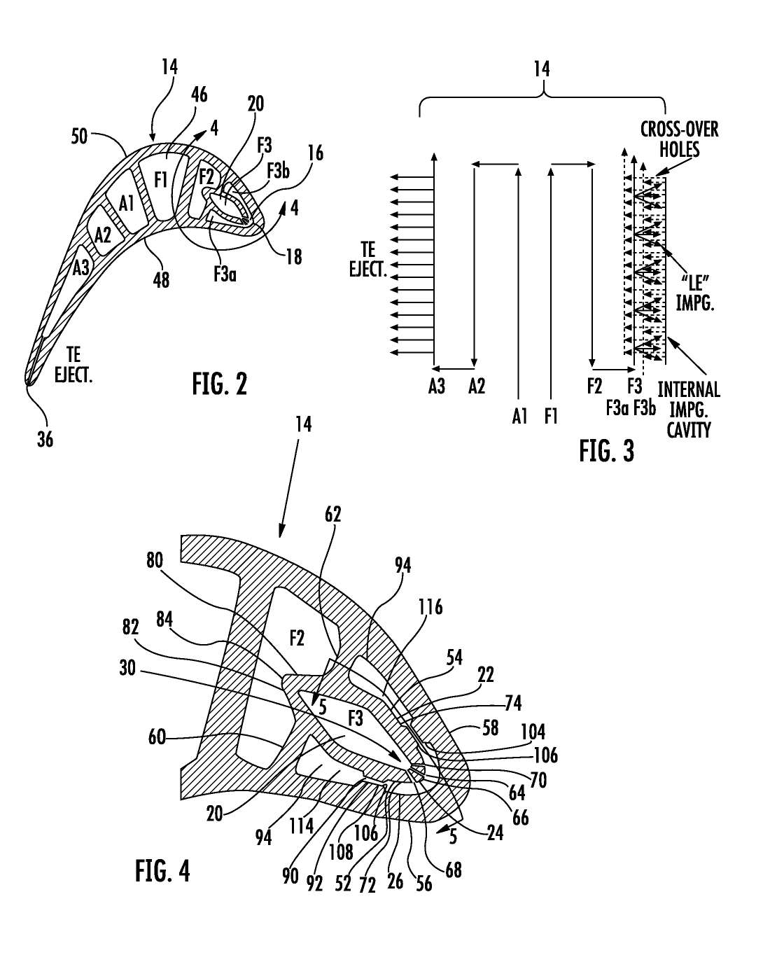

In at least one embodiment, as shown in FIG. 1, the turbine airfoil 10 may be a turbine blade or vane. The turbine airfoil 10 may be formed from a generally elongated, hollow airfoil 28 having a leading edge 18, a trailing edge 36, a pressure side 48, a suction side 50, a tip 38 at a first end 40, a root 42 coupled to the airfoil 10 at a second end 44 generally opposite to the first end 40 for supporting the airfoil 10 and for coupling the airfoil 10 to a disc, and a cooling system 14 formed from at least one cavity 46 in the elongated, hollow airfoil 28. The internal cooling system 14 may include a leading edge cooling supply channel 20 and a leading edge impingement channel 16 positioned within the generally elongated, hollow airfoil 28 along the leading edge 18 of the generally elongated, hollow airfoil 28, as shown in FIGS. 2-4. The leading edge cooling supply channel 20 may be formed from a leading edge wall 22 having a leading edge tip 24 that is advanced closer to the inner surface 26 of the leading edge 18 of the generally elongated, hollow airfoil 28 than other aspects of the leading edge cooling supply channel 20.

The leading edge cooling supply channel 20 may be formed from a first leading edge wall 52 that extends spanwise and a second leading edge wall 54 that extends spanwise and is coupled to the first leading edge wall 52 forming the leading edge tip 24. The first leading edge wall 52 may be nonorthogonal to the second leading edge wall 54. In at least one embodiment, as shown in FIGS. 2 and 4, the first leading edge wall 52 may be aligned with an outer wall 56 forming the pressure side 48 of the generally elongated hollow airfoil 28. The second leading edge wall 54 may be aligned with an outer wall 58 forming the suction side 50 of the generally elongated hollow airfoil 28. The leading edge cooling supply channel 20 may be offset from the outer wall 56 forming the pressure side 48 and the outer wall 58 forming the suction side 50 of the generally elongated hollow airfoil 28. The leading edge cooling supply channel 20 may be supported by a pressure side rib 60 extending between the outer wall 56 forming the pressure side 48 of the generally elongated hollow airfoil 28 and the first leading edge wall 52 of the leading edge cooling supply channel 20. The leading edge cooling supply channel 20 may also be supported by a suction side rib 62 extending between the outer wall 58 forming the suction side 50 of the generally elongated hollow airfoil 28 and the second leading edge wall 54 of the leading edge cooling supply channel 20. The leading edge cooling supply channel 20 may also be formed from a first aft edge wall 80 that extends spanwise and a second aft edge wall 82 that extends spanwise and is coupled to the first aft edge wall forming a trailing edge tip 84. The first aft edge wall 80 may be nonorthogonal to the second aft edge wall 82.

The internal cooling system 14 may include one or more leading edge impingement orifices 30 in the leading edge tip 24 of the leading edge cooling supply channel 20 for exhausting cooling fluids to impinge on the inner surface 26 of the leading edge 18 of the generally elongated, hollow airfoil 28 in a leading edge impingement channel 16. In at least one embodiment, the internal cooling system 14 may include a plurality of leading edge impingement orifices 30 aligned into a spanwise extending row of leading edge impingement orifices 30. In at least one embodiment, there may be multiple spanwise extending rows of leading edge impingement orifices 30, such as, but not limited to, a first spanwise extending row 64 at a stagnation line 66, a second spanwise extending row 68 on the pressure side 48 of the stagnation line 66 and a third spanwise extending row 70 on the suction side 50 of the stagnation line 66. The leading edge impingement orifices 30 may have any appropriate sized opening and cross-sectional area and shape.

The first and second leading edge walls 52, 54 of the leading edge cooling supply channel 20 may define a portion of the leading edge impingement channel 16 formed from a pressure side section 72 and a suction side section 74 that is nonorthogonal to the pressure side section 72. The pressure side section 72 and the suction side section 74 of the leading edge impingement channel 16 may form a c-shaped cross-sectional leading edge impingement channel 16.

The internal cooling system 14 may include the leading edge impingement orifices 30 but may not exhaust cooling fluids through the leading edge 18 of the airfoil 10. Rather, the cooling fluids may be exhausted through the radially inner or outer ends 40, 44 of the leading edge impingement channel 16. This configuration may develop significant cross flow near the tip 38 or elsewhere, which may degrade the effectiveness of the leading edge impingement orifices 30. However, the reduced distance between the leading edge tip 24 housing the leading edge impingement orifices 30 and the inner surface 26 of the leading edge 18 of the airfoil 10 should lower the negative impact versus conventional configurations.

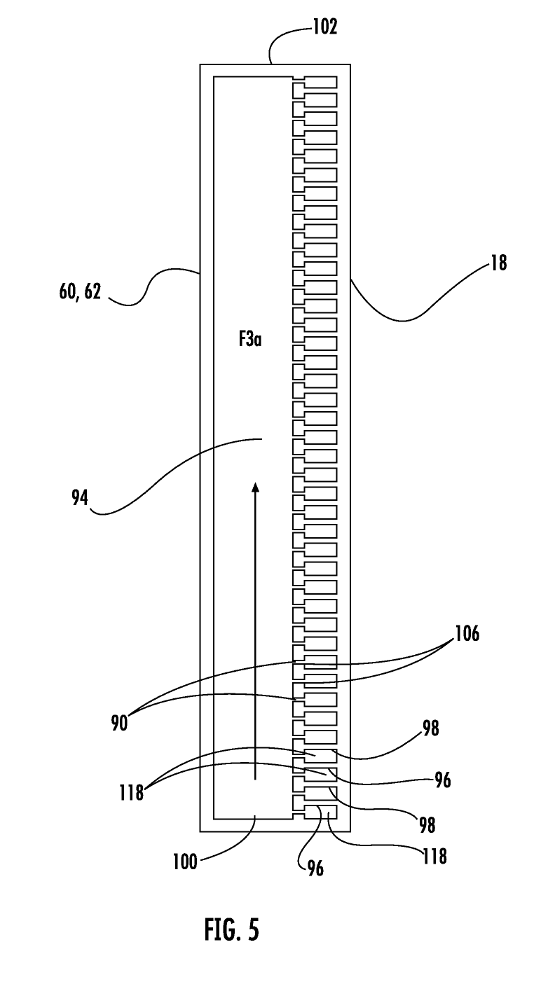

As shown in FIGS. 4 and 5, the internal cooling system 14 may include one or more nearwall impingement orifices 90 positioned within a nearwall rib 92 in the leading edge cooling supply channel 20. The internal cooling system 14 may also include one or more nearwall radial flow channels 94 aft of the nearwall rib 92 such that the nearwall radial flow channels 94 receive impingement cooling fluids after the fluids have flowed through the nearwall impingement orifices 90. The nearwall radial flow channel 94 may include a pressure side nearwall radial flow channel 114 and a suction side nearwall radial flow channel 116. The pressure side nearwall radial flow channel 114 and the suction side nearwall radial flow channel 116 direct cooling fluids from the airfoil 10 and exhaust the cooling fluids from the internal cooling system 14.

The nearwall rib 92 may extend spanwise within the leading edge cooling supply channel 20 from an ID end 100 of the leading edge cooling supply channel 20 to an OD end 102 of the leading edge cooling supply channel 20. The nearwall rib 92 may extend between the pressure side 48 and a first leading edge section 52 of the leading edge wall forming the leading edge cooling supply channel 20 and forms a pressure side nearwall rib 104. In at least one embodiment, the internal cooling system 14 may include a plurality of nearwall impingement orifices 90 positioned within the pressure side nearwall rib 104.

The internal cooling system 14 may also include a first chordwise extending impingement rib 96 separated spanwise from a second chordwise extending impingement rib 98. In at least one embodiment, the internal cooling system 14 may include a plurality of first and second chordwise extending impingement ribs 96, 98 extending chordwise from the pressure side nearwall rib 104. The first and second chordwise extending impingement ribs 96, 98 may be offset spanwise from inlets 106 of the nearwall impingement orifices 90. The first and second chordwise extending impingement ribs 96, 98 may extend toward the leading edge 18 from the nearwall rib 92. The first and second chordwise extending impingement ribs 96, 98 reduce crossflow and direct cooling fluid into the channels 118 formed between the first and second chordwise extending impingement ribs 96, 98 and toward the nearwall impingement orifices 90.

The nearwall impingement orifices 90 may be positioned such that impingement fluids exiting the nearwall impingement orifices 90 are directed to contact the inner surface 26 of the outer wall 56 forming the pressure side 48 or the inner surface 26 of the outer wall 58 forming the suction side 50, or both. The nearwall impingement orifices 90 may be angled such that a longitudinal axis of a nearwall impingement orifice 90 may intersect the inner surface 26 of the outer wall 56 forming the pressure side 48 or the inner surface 26 of the outer wall 58 forming the suction side 50.

One or more nearwall ribs 92 may extend between the suction side 50 and a second leading edge section 54 of the leading edge wall forming the leading edge cooling supply channel 20 and may form a suction side nearwall rib 108. In at least one embodiment, the internal cooling system 14 may include a plurality of nearwall impingement orifices 90 positioned within the suction side nearwall rib 108. The internal cooling system 14 may also include a plurality of first and second chordwise extending impingement ribs 96, 98 extending chordwise from the suction side nearwall rib 108. The first and second chordwise extending impingement ribs 96, 98 may be offset spanwise from inlets 106 of the plurality of the nearwall impingement orifices 90.

During use, cooling fluids, such as, but not limited to, air, may be supplied to the internal cooling system 14. The cooling fluids may enter the leading edge cooling supply channel 20 and flow spanwise throughout the leading edge cooling supply channel 20. The cooling fluids may flow through the leading edge impingement orifices 30 and may impinge on the inner surface 26 of the leading edge 18. The cooling fluids may increase in temperature due to convection and may flow along the inner surface forming the pressure and suction sides 48, 50. The plurality of first and second chordwise extending ribs 96, 98 may reduce crossflow and direct the impingement fluids towards the nearwall impingement orifices 90 in the nearwall ribs 92. The cooling fluids may be exhausted from the leading edge impingement channel 16 and the channels 118 formed by the first and second chordwise extending ribs 96, 98 through nearwall impingement orifices 90 in the nearwall ribs 92. The cooling fluids impinge on the inner surface 26 of the outer wall 56 on the pressure side 48 and the inner surface 26 of the outer wall 58 on the suction side 50. The cooling fluids flow spanwise within the radial flow channels 94 of the leading edge impingement channel 16 aft of the nearwall ribs 92.

The foregoing is provided for purposes of illustrating, explaining, and describing embodiments of this invention. Modifications and adaptations to these embodiments will be apparent to those skilled in the art and may be made without departing from the scope or spirit of this invention.

1. A turbine airfoil for use in a gas turbine engine, comprising:
a generally elongated, hollow airfoil having a leading edge, a trailing edge, a pressure side, a suction side, a first end, a second end generally opposite to the first end for supporting the airfoil, and an internal cooling system formed from at least one cavity in the elongated, hollow airfoil;
the internal cooling system including a leading edge cooling supply channel and a leading edge impingement channel positioned within the generally elongated, hollow airfoil along the leading edge of the generally elongated, hollow airfoil;
wherein the leading edge cooling supply channel is formed from a leading edge wall having a leading edge tip that is advanced closer to an inner surface of the leading edge of the generally elongated, hollow airfoil than other aspects of the leading edge cooling supply channel;
at least one leading edge impingement orifice in the leading edge tip of the leading edge cooling supply channel for exhausting cooling fluids to impinge on the inner surface of the leading edge of the generally elongated, hollow airfoil in a leading edge impingement channel;
at least one nearwall impingement orifice positioned within a nearwall rib in the leading edge cooling supply channel;
at least one nearwall radial flow channel positioned aft of and downstream from the at least one nearwall impingement orifice; and
a first chordwise extending impingement rib separated spanwise from a second chordwise extending impingement rib, wherein the first chordwise extending impingement rib and the second chordwise extending impingement rib extend between the nearwall rib containing the at least one nearwall impingement orifice and leading edge of the airfoil.

2. The turbine airfoil of claim 1, wherein in that the at least one nearwall rib extends spanwise within the leading edge cooling supply channel from an ID end of the leading edge cooling supply channel to an OD end of the leading edge cooling supply channel.

3. The turbine airfoil of claim 1, wherein in that the at least one nearwall rib extends between the pressure side and a first leading edge section of the leading edge wall forming the leading edge cooling supply channel and forms a pressure side nearwall rib.

4. The turbine airfoil of claim 3, wherein in that the at least one nearwall impingement orifice positioned within the nearwall rib in the leading edge cooling supply channel comprises a plurality of nearwall impingement orifices positioned within the pressure side nearwall rib.

5. The turbine airfoil of claim 4, wherein in that the first and second chordwise extending impingement ribs comprise a plurality of first and second chordwise extending impingement ribs extending chordwise from the pressure side nearwall rib, wherein the first and second chordwise extending impingement ribs are offset spanwise from inlets of the plurality of the nearwall impingement orifices.

6. The turbine airfoil of claim 1, wherein in that the at least one nearwall rib extends between the suction side and a second leading edge section of the leading edge wall forming the leading edge cooling supply channel and forms a suction side nearwall rib.

7. The turbine airfoil of claim 6, wherein in that at least one nearwall impingement orifice positioned within a nearwall rib in the leading edge cooling supply channel comprises a plurality of nearwall impingement orifices positioned within the suction side nearwall rib.

8. The turbine airfoil of claim 7, wherein in that the first and second chordwise extending impingement ribs comprise a plurality of first and second chordwise extending impingement ribs extending chordwise from the suction side nearwall rib, wherein the first and second chordwise extending impingement ribs are offset spanwise from inlets of the plurality of the nearwall impingement orifices.

9. The turbine airfoil of claim 1, wherein in that the leading edge cooling supply channel is formed from a first leading edge wall that extends spanwise and a second leading edge wall that extends spanwise and is coupled to the first leading edge wall forming the leading edge tip, wherein the first leading edge wall is nonorthogonal to the second leading edge wall.

10. The turbine airfoil of claim 9, wherein in that the first and second leading edge walls of the leading edge cooling supply channel define a portion of the leading edge impingement channel formed from a pressure side section and a suction side section that is nonorthogonal to the pressure side section.

11. The turbine airfoil of claim 10, wherein in that the pressure side section and the suction side section of the leading edge impingement channel form a c-shaped cross-sectional leading edge impingement channel.

12. The turbine airfoil of claim 9, wherein in that the first leading edge wall is aligned with an outer wall forming the pressure side of the generally elongated hollow airfoil, and the second leading edge wall is aligned with an outer wall forming the suction side of the generally elongated hollow airfoil.

13. The turbine airfoil of claim 9, wherein in that the leading edge cooling supply channel is formed from a first aft edge wall that extends spanwise and a second aft edge wall that extends spanwise and is coupled to the first aft edge wall forming a trailing edge tip, wherein the first aft edge wall is nonorthogonal to the second aft edge wall.

14. The turbine airfoil of claim 13, wherein in that the leading edge cooling supply channel is offset from an outer wall forming the pressure side and an outer wall forming the suction side of the generally elongated hollow airfoil.

15. The turbine airfoil of claim 14, wherein in that the leading edge cooling supply channel is supported by a pressure side rib extending between the outer wall forming the pressure side of the generally elongated hollow airfoil and the first aft edge wall of the leading edge cooling supply channel and is supported by a suction side rib extending between the outer wall forming the suction side of the generally elongated hollow airfoil and the second aft edge wall of the leading edge cooling supply channel.

16. The turbine airfoil of claim 1, wherein in that the at least one leading edge impingement orifice in the leading edge tip of the leading edge cooling supply channel is formed from a plurality of leading edge impingement orifices aligned into at least one spanwise extending row of leading edge impingement orifices.
